(19) United States
(12) Patent Application Publication
(10) Pub. No.: US 2026/0232123 A1
(43) Pub. Date: Aug. 13, 2026

(54) FILTER FOR DRINKING STRAW

(71) Applicant: AGA Imports LLC, Lakewood, NJ (US)

(72) Inventor: Albert Grazi, Lakewood, NJ (US)

(73) Assignee: AGA Imports LLC, Lakewood, NJ (US)

(21) Appl. No.: 19/048,306

(22) Filed: Feb. 7, 2025

(51) Int. Cl. A47G 21/18; B01D 35/30; C02F 1/00

(52) U.S. Cl. CPC A47G 21/188; B01D 35/30; C02F 1/002; B01D 2201/301; B01D 2201/4092

(57) ABSTRACT

A water filtering unit that can be selectively attached to the end of a drinking straw. The unit is formed of a cylindrical housing that contains a filter cartridge. The top of the housing is configured to temporarily attach to a bottom end of drinking straw. The bottom of the housing contains an opening for the inlet of water. In use, a user attaches the filter unit to the straw and then drinks with the straw and attached filter, thereby filtering water during the course of drinking the same.

### FIELD OF THE INVENTION

The invention relates to water filters, more specifically to a water filter that is attachable to a drinking straw.

### BACKGROUND OF THE INVENTION

People across the world drink water from various sources. Often water will contain impurities or can be less than ideal for consumption. Moreover, there are often situations where access to clean water is limited, such as during outdoor activities, travel, or emergency scenarios. Filtering systems are relatively large and expensive and are not well adapted for portability.

### SUMMARY OF THE INVENTION

Embodiments of the invention provide a filter that is attachable to a drinking straw. The filter set forth in the invention is formed of a slender barrel that is attachable via frictional engagement to a bottom opening of a straw. The barrel has an opening that allows water to be drawn into the barrel. Water entering the barrel passes through a filter cartridge and then filtered water continues to the attached straw.

Drinking straws equipped with attachable filters in accordance with embodiments of the invention offer an effective way to remove contaminants, such as bacteria, microplastics, and sediments from drinking water in a lightweight, compact and inexpensive manner.

### BRIEF DESCRIPTION OF THE FIGURES

FIG. 1 is a side perspective view of a filter unit attached to a straw in accordance with an embodiment of the invention.

FIG. 2 is a side perspective exploded view of a filter unit and straw in accordance with an embodiment of the invention.

FIG. 3 is a side perspective view of a cap for filter unit in accordance with an embodiment of the invention.

FIG. 4 is an exploded view of a filter unit in accordance with an embodiment of the invention.

FIG. 5 is an exploded view of a filter unit in accordance with an embodiment of the invention.

FIG. 6 is a top view of a filter unit in accordance with an embodiment of the invention.

FIG. 7 is a bottom view of a filter unit in accordance with an embodiment of the invention.

### DETAILED DESCRIPTION OF THE INVENTION

Embodiments of the present invention will now be described with reference to the above-identified figures of the drawings. However, the drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

In embodiments of the invention, a filter unit 10 is a substantially cylindrical-shaped device that is attachable to a bottom end of a drinking straw.

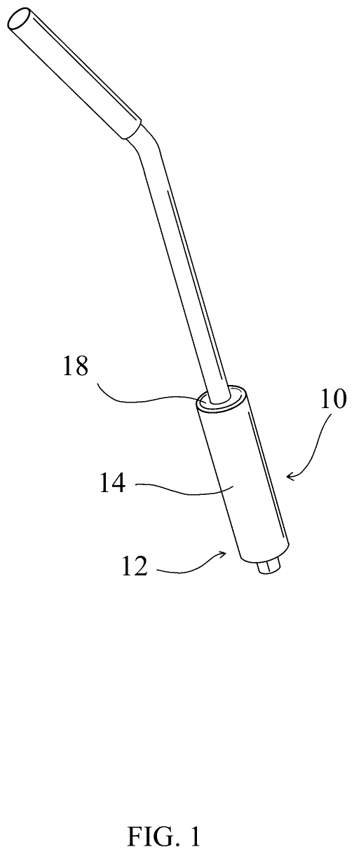

Referring to FIG. 1, filter unit 10 includes a housing barrel 12 formed of a rounded wall 14 that is substantially cylindrical. In embodiments of the invention, housing barrel 12 is provided with a bottom base plate 21 (best shown in FIG. 7). Bottom base plate 21 forms a floor of housing barrel 14. An underside surface of bottom base plate 21 is shown in FIG. 7. As shown, an opening 23 is made in bottom base plate 21 to allow the inflow of water.

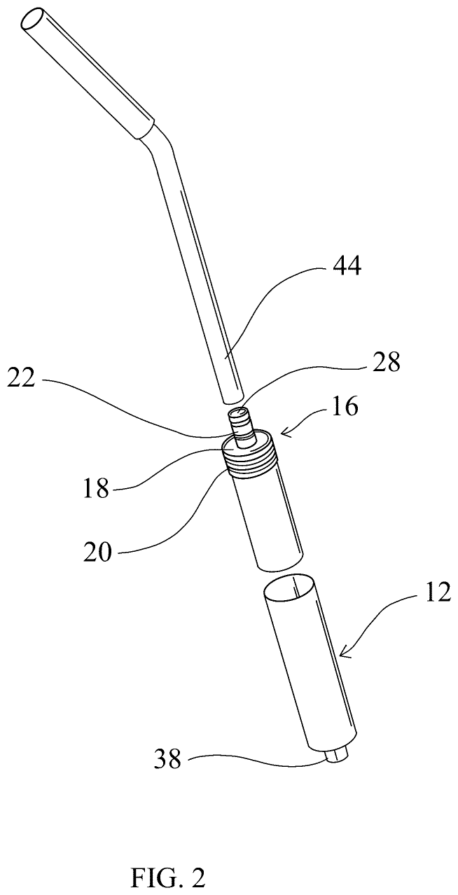

With reference to FIG. 2, in an embodiment of the invention, a lower intake shaft 38 extends downward from housing barrel 12. Opening 23 is provided at the bottom end of intake shaft 38.

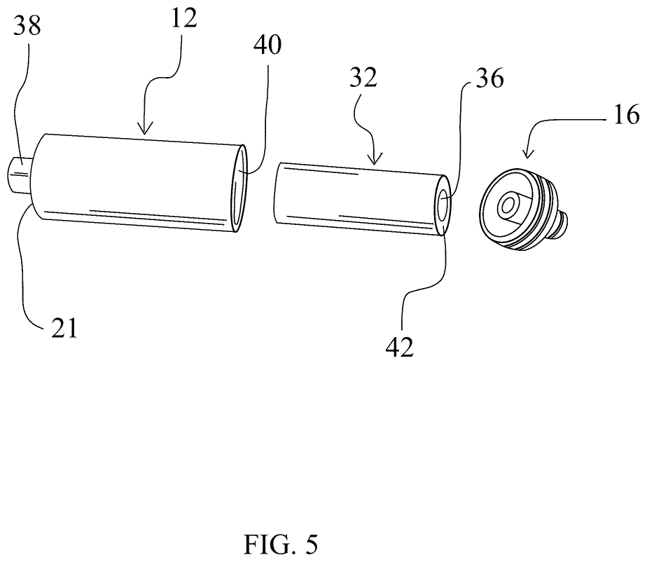

With reference FIGS. 2-5, a cap 16 is provided to mate with housing barrel 12. In embodiments of the invention, cap 16 is formed of a plate 18 having an upper surface and an underside surface. A collar 20 extends downwardly from plate 18. In an embodiment of the invention, collar 20 includes threads for mating with cooperating threads on an interior surface of housing barrel 12. In other embodiments of the invention, collar 20 is provided with ridges or similar abutments that create a frictional surface for engaging the interior circumference of housing barrel 12. In embodiments of the invention, when collar 20 is seated in housing barrel 12, a fluid tight seal is formed.

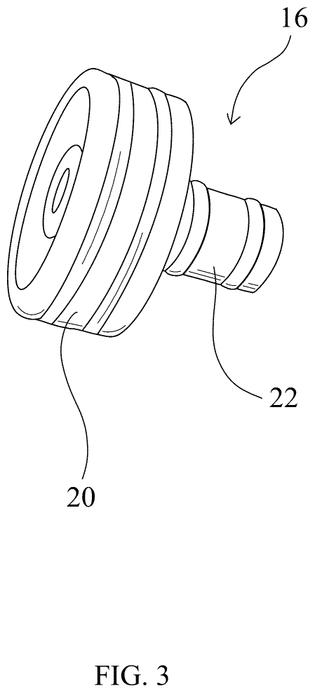

FIG. 3 shows a perspective side view of cap 16 in accordance with an embodiment of the invention. As shown, an upward projecting hollow post 22 (“upward post”) extends upwardly from plate 18. Upward post 22 is a cylindrical member having a channel formed therethrough. Upward post 22 has a first end that emanates from plate 18 and a second terminal end.

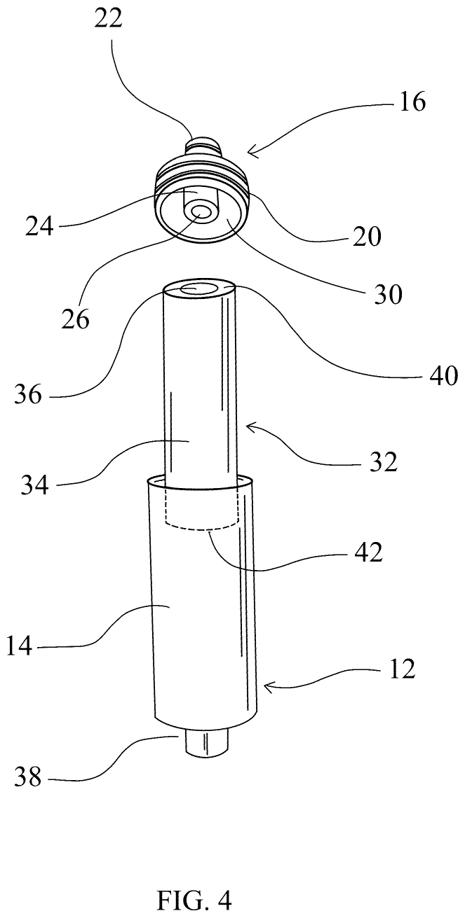

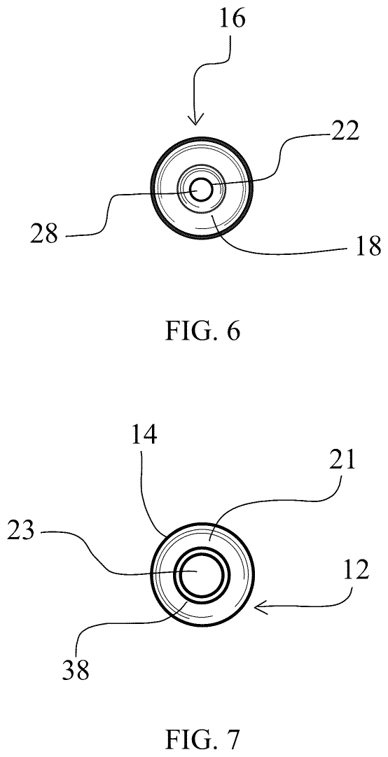

As best shown in FIG. 4, a downward projecting hollow post 24 (“downward post”) extends downwardly from underside of plate 18. In embodiments of the invention, downward post 24 terminates in a cavity formed by collar 20. In embodiments, downward post 24 has an opening 26 on its terminal lower end. In this regard, a channel is formed between opening 26 on downward post 24 and opening 28 formed in upward post 22 thereby allowing fluid communication between the interior of housing barrel 12 and a straw that is attached to the filter unit 10. FIG. 6 shows a top plan view of cap 16 showing opening 28 in upward post 22.

With continued reference to FIG. 4 as shown, a filter engagement area is formed by inside surface 30 of collar 20, the underside surface of plate 18 and the outside surface of downward post 24.

In embodiments of the invention, a filter member is provided to be stored and secured within housing barrel 14. As shown in FIG. 4, in an embodiment of the invention, filter 32 is substantially cylindrically shaped having an upper surface 40, a bottom surface 42 and rounded outside walls 34. In the embodiments shown, top and bottom surfaces 40, 42 are substantially disc-shaped. Top surface 40 of filter 32 is provided with a channel 36 that at least partially extends into the filter and is substantially sized and shaped to receive downward post 24 of cap 16. In embodiments of the invention, filter 32 is secured to cap 16 in a manner whereby downward post 24 inserts into and frictionally engages with filter channel 36 and inside surface 30 of collar 20 captures an upper segment of outside walls 34 of filter 32. It will be understood that a bottom surface 42 of filter 32 may rest on base plate 21 of housing barrel 12.

It will be understood that filter 32 is formed of a substance that can trap contaminants. For example, filter 32 may be formed of or include in combination charcoal or similar activated carbon material, ceramic, hollow fiber membranes, or ion exchange resins.

Housing chamber and cap is preferably formed of a food grade plastic, such as for example, BPA-Free Plastic.

In embodiments of the invention, filter unit 10 is configured to be selectively connected to a drinking straw. In this regard, as shown, upward post 22 is sized and shaped to insert into and frictionally engage with an interior lower end of a drinking straw (e.g. 44 shown in FIG. 2). It will be understood that upward post may be provided with frictional elements such as abutting rings or similar projections configured to create a tight frictional connection between outside surface of upward post 22 and an interior wall of a lower segment of a straw.

It will be understood that straw 44 is preferably a reusable straw formed of a durable eco-friendly such as for example stainless steel or the like. In other embodiments, filter unit 10 is configured to be attachable to a plastic disposable drinking straw.

FIG. 1 shows a filter unit fully assembled in accordance with an embodiment of the invention. As shown, cap 16 is fully seated in an upper segment of filter barrel 12 (such that substantially only plate 18 is visible). Filter 32 is stored therein (not shown). A straw is shown attached to upward post 22. Upward post 22 is not visible in FIG. 1 given that it is fully inserted into the lower end of the straw.

In use, a user attaches filter unit 12 to a straw via upward post 22 and inserts filter unit (or at least a bottom segment thereof) into a cup of water. The user then drinks via the straw in a normal fashion. In this regard, reduced pressure in the straw (via suction) will cause reduced pressure in the filter unit will, which causes water in the cup to enter the filter unit through opening 23 of lower intake shaft 38. Water will then pass through the filter 32. Filtered water will then pass through opening 26 of downward post and enter the straw through opening 28. Embodiments of the invention thus provide a compact filter that is easily portable and that can be temporarily attached to existing drinking straws that are readily available on the market.

While this invention has been described in conjunction with the embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1) A portable filter unit comprising:
a. a housing sized and shaped to receive a filter, comprising:
a housing barrel having rounded walls and a base plate having an opening therein;
a cap having a plate and a collar extending downwardly from the plate, an upward projecting hollow post extending upwardly from the plate and a downward projecting hollow post extending downwardly from the plate, the cap configured to be seated in an upper segment of the housing barrel;
b. a filter being shaped and sized to be maintained within the housing, the filter being formed of a material capable of separating contaminants from water.

2) The portable filter unit of claim 1, further comprising a lower intake shaft extending downwardly from the base plate.

3) The portable filter unit of claim 1, whereby the upward projecting hollow post is sized and shaped to insert into a lower end of a straw.

4) The portable filter unit of claim 1, whereby the filter comprises an upper surface, a bottom surface, and rounded walls.

5) The portable filter unit of claim 4, further comprising a channel opening in the upper surface of the filter.

6) The portable filter unit of claim 5, whereby the channel is sized and shaped to receive the downward projecting hollow post.

7) The portable filter unit of claim 1, whereby the collar of the cap is configured to be received in the housing barrel to create a fluid tight seal.
